(19) United States
(12) Patent Application Publication
(10) Pub. No.: US 2024/0337853 A1
(43) Pub. Date: Oct. 10, 2024

(54) DISPLAY CALIBRATION METHOD AND APPARATUS FOR HEAD-MOUNTED DEVICE, HEAD-MOUNTED DEVICE, AND STORAGE MEDIUM

(71) Applicant: GOERTEK TECHNOLOGY CO., LTD., SHANDONG (CN)

(72) Inventors: QINGKAI ZHANG, Shandong (CN); PINGPING WANG, Shandong (CN)

(73) Assignee: GOERTEK TECHNOLOGY CO., LTD., SHANDONG (CN)

(21) Appl. No.: 18/293,616

(22) PCT Filed: Jul. 21, 2022
(86) PCT No.: PCT/CN2022/107090

§ 371 Date: Jan. 30, 2024

(30) Foreign Application Priority Data
Jul. 30, 2021 (CN) 202110875887.9

(51) Int. Cl. G02B 27/01

(52) U.S. Cl. CPC G02B 27/0179; G02B 27/0172; G02B 2027/0138; G02B 2027/0187

(57) ABSTRACT

A display calibration method for a head-mounted device is disclosed in the present disclosure. The method comprises: controlling a camera to take a first eye image when a user wears the head-mounted device; determining a human eye gazing position according to the first eye image, wherein the human eye gazing position is a position of a human eye gazing point on the head-mounted device; retrieving a preset gazing position of the head-mounted device and calculating positional deviation information of the preset gazing position compared to the human eye gazing position; and adjusting a screen display position of the head-mounted device according to the positional deviation information.

### CROSS-REFERENCE TO RELATED APPLICATIONS

The present disclosure is a National Stage of International Application No. PCT/CN2022/107090, filed on Jul. 21, 2022, which claims priority to a Chinese patent application No. CN 202110875887.9 filed on Jul. 30, 2021 and entitled “DISPLAY CALIBRATION METHOD AND APPARATUS FOR HEAD-MOUNTED DEVICE, HEAD-MOUNTED DEVICE, AND STORAGE MEDIUM”, both of which are hereby incorporated by reference in their entireties.

### TECHNICAL FIELD

The present disclosure relates to the field of Augmented Reality (AR), particularly to a display calibration method and apparatus for a head-mounted device, a head-mounted device and a storage medium.

### BACKGROUND

A head-mounted devices based on AR technology and VR (Virtual Reality) technology has been widely used.

Due to process tolerances during the production of the head-mounted device and collisions during actual use of the head-mounted device, the head-mounted device has a certain deformation relative to a standard device, which will lead to a phenomenon such as convergence conflict and binocular visual overlap when a user uses the head-mounted device, negatively influencing the display effect of the head-mounted device.

Therefore, how to correct an image display error caused by deformation of a head-mounted device and automatically realize display calibration of the head-mounted device has become a technical problem to be solved by those skilled in the art at present.

### SUMMARY

A main objective of the present disclosure is to provide a display calibration method, apparatus for a head-mounted device, an electronic equipment and a storage medium, which can correct the image display error caused by the deformation of the head-mounted device and automatically realize the display calibration of the head-mounted device.

To achieve the above objective, the present disclosure proposes a display calibration method for a head-mounted device, which comprises:
controlling a camera to take a first eye image when a user wears the head-mounted device;
determining a human eye gazing position according to the first eye image, wherein the human eye gazing position is a position of a human eye gazing point on the head-mounted device;
retrieving a preset gazing position of the head-mounted device and calculating positional deviation information of the preset gazing position compared to the human eye gazing position; and
adjusting a screen display position of the head-mounted device according to the positional deviation information.

Optionally, the head-mounted device is provided with a plurality of infrared light emitting diodes on its border:
“determining a human eye gazing position according to the first eye image” comprises;
determining a gazing direction according to a relative position of projection of the infrared light emitting diodes in a human eye in the first eye image with respect to a pupil;
calculating the human eye gazing position according to the gazing direction and a human eye position.

Optionally, the head-mounted device is an AR head-mounted device, and “adjusting a screen display position of the head-mounted device according to the positional deviation information” comprises:
generating a control command according to the positional deviation information and adjusting the screen display position of the head-mounted device by sending the control command to a stepper motor: wherein the control command is a command for adjusting relative positions of an AR optical machine and an AR lens.

Optionally, “generating a control command according to the positional deviation information” comprises:
determining a coordinate offset of a display screen according to the positional deviation information, and generating the control command according to the coordinate offset of the display screen.

Optionally, before taking a first eye image when a user wears the head-mounted device, further comprising:
displaying a reference picture in a display area of the head-mounted device, wherein the reference picture comprises a plurality of feature points that are all symmetrically distributed with respect to the preset gazing position.

Optionally, after adjusting a screen display position of the head-mounted device according to the positional deviation information, further comprising:
controlling the camera to take a second eye image, and judging whether positional deviation information of a human eye gazing position corresponding to the second eye image compared to the preset gazing position meets a preset condition;
if yes, outputting a prompt message indicating that a calibration is completed;
if not, adjusting the screen display position of the head-mounted device according to current positional deviation information.

Optionally, further comprising:
when the head-mounted device is detected to be in a wearing state, judging whether a facial feature of a current user is the same as that of a previous user;
if not, returning to the step of controlling a camera to take a first eye image.

The disclosure also proposes a display calibrating apparatus for a head-mounted device, which comprises:
an image taking module configured for controlling a camera to take a first eye image when a user wears the head-mounted device;
a gazing position detecting module configured for determining a human eye gazing position according to the first eye image, wherein the human eye gazing position is a position of a human eye gazing point on the head-mounted device;
a deviation determining module configured for retrieving a preset gazing position of the head-mounted device and calculating positional deviation information of the preset gazing position compared to the human eye gazing position; and
a display calibrating module configured for adjusting a screen display position of the head-mounted device according to the positional deviation information.

The present disclosure also proposes a storage medium where a computer program is store, and the computer program, when executed, implements steps executed by the above display calibration method for a head-mounted device.

The present disclosure also proposes an electronic equipment comprising a memory and a processor, the memory stores a computer program therein, and the processor is configured for implementing steps executed by the above display calibration method for a head-mounted device when calling the computer program in the memory.

The present disclosure provides a display calibration method for a head-mounted device, comprising: controlling a camera to take a first eye image when a user wears the head-mounted device: determining a human eye gazing position according to the first eye image, wherein the human eye gazing position is a position of a human eye gazing point on the head-mounted device: retrieving a preset gazing position of the head-mounted device and calculating positional deviation information of the preset gazing position compared to the human eye gazing position; and adjusting a screen display position of the head-mounted device according to the positional deviation information

The present disclosure determines the human gazing position by taking a first eye image when a user wears the head-mounted device, and may determine the position of the human eye gazing point on the head-mounted device according to the human eye gazing position. The head-mounted device is provided with a preset gazing position so as to avoid the occurrence of convergence conflict and binocular vision overlap, such that there is no convergence conflict and no binocular visual overlap when the human eye gazing position is the preset gazing position. The present disclosure compares the preset gazing position with the human eye gazing position, and adjusts the screen display position according to the positional deviation information, thereby realizing the adjustment of the display screen of the head-mounted device. By adjusting the screen display position based on the actual human eye gazing position and the preset gazing position, the above solution can correct the image display error caused by the deformation of the head-mounted device and automatically realize the display calibration of the head-mounted device. The present disclosure also proposes a display calibrating apparatus for a head-mounted device, an electronic equipment and a storage medium, which have the above beneficial effects, and will not be repeated herein.

### BRIEF DESCRIPTION OF THE DRAWINGS

In order to clearly illustrate embodiments of the present disclosure, accompanying drawings that need to be used in the embodiments will be briefly introduced as follows. Obviously, drawings in following description are only the embodiments of the present disclosure. For those skilled in the art, other drawings can also be obtained according to the disclosed drawings without creative efforts.

FIG. 1 is a flow chart of a display calibration method for a head-mounted device provided by an embodiment of the present disclosure;

FIG. 2 is a schematic diagram of a reference picture provided by an embodiment of the present disclosure:

FIG. 3 is a schematic diagram of a binocular calibration process for an AR glass provided by an embodiment of the present disclosure:

FIG. 4 is a control logic diagram of binocular calibration for an AR glass provided by an embodiment of the present disclosure:

FIG. 5 is a schematic structural illustration of a display calibrating apparatus for a head-mounted device provided by an embodiment of the present disclosure.

### DETAILED DESCRIPTION

In order to make the purpose, technical solution and advantages of the embodiments of the present disclosure clearer, the technical solutions in the embodiments of the present disclosure will be clearly and completely described below in conjunction with the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

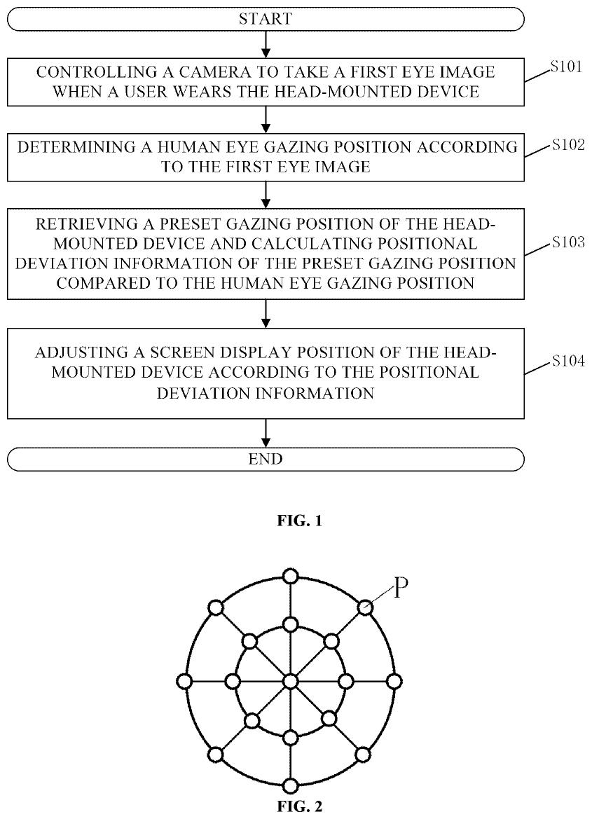

Referring to FIG. 1 below, FIG. 1 is a flow chart of a display calibration method for a head-mounted device provided by an embodiment of the present disclosure.

Specific Steps May Comprise:

S101, controlling a camera to take a first eye image when a user wears the head-mounted device;

wherein, the present embodiment may be applied to a System On Chip (SOC) of the head-mounted device, and may also be applied to a terminal device (e.g., a cellphone, a tablet computer, etc.) that controls the head-mounted device. The head-mounted device referred to in the present embodiment may include AR glasses, VR helmets, and the like.

Before this step, there may be an operation of receiving a display calibration instruction, which may be an instruction manually input by a user or an instruction automatically generated by a head-mounted device under a specific trigger condition. The specific trigger condition may be that the head-mounted device is impacted, the wearer of the head-mounted device is changed, and the like.

S102: determining a human eye gazing position according to the first eye image;

The first eye image in the present embodiment may include a left-eye image, and may also include a right-eye image: the present embodiment may determine a human eye gazing position according to information in the first eye image such as pupil angle, pupil size, etc. The human eye gazing position is a position of a human eye gazing point on the head-mounted device: the above human eye gazing position includes a position of a human eye gazing point (including a left-eye gazing point and a right-eye gazing point) at the head-mounted device.

S103: retrieving a preset gazing position of the head-mounted device and calculating positional deviation information of the preset gazing position compared to the human eye gazing position:

Here, the present embodiment may retrieve a configuration file of the head-mounted device and determine a preset gazing position of the head-mounted device. It can be understood that both the left eye and the right eye can have their corresponding preset gazing position, and in order to avoid visual fatigue caused by binocular visual overlap, the preset gazing positions corresponding to the left eye and the right eye are symmetrically distributed with respect to the center of symmetry of the head-mounted device.

The human eye gazing position obtained in S101 is the actual gazing position, and the preset gazing position is an ideal gazing position when designing the head-mounted device. The present embodiment may obtain positional deviation information by comparing the preset gazing position with the human eye gazing position. The above positional deviation information may include the position deviation of X, Y and Z axes.

S104: adjusting a screen display position of the head-mounted device according to the positional deviation information.

Here, before this step, there may be an operation to judge whether the positional deviation information meets an adjustment condition: specifically, if the absolute value of the deviation in the X-axis direction is greater than a first preset value, it is determined that the positional deviation information meets the adjustment conditions: if the absolute value of the deviation in the Y-axis direction is greater than a second preset value, it is determined that the positional deviation information meets the adjustment condition: if the absolute value of the deviation in the Z-axis direction is greater than a third preset value, it is determined that the positional deviation information meets the adjustment condition. On the premise that the positional deviation information meets the adjustment condition, the present embodiment may adjust the screen display position of the head-mounted device according to the positional deviation information.

The present embodiment determines the human gazing position by taking a first eye image when a user wears the head-mounted device, and may determine the position of the human eye gazing point on the head-mounted device according to the human eye gazing position. The head-mounted device is provided with a preset gazing position so as to avoid the occurrence of convergence conflict and binocular vision overlap, such that there is no convergence conflict and no binocular visual overlap when the human eye gazing position is the preset gazing position. The present embodiment compares the preset gazing position with the human eye gazing position, and adjusts the screen display position according to the positional deviation information, thereby realizing the adjustment of the display screen of the head-mounted device. By adjusting the screen display position based on the actual human eye gazing position and the preset gazing position, the above solution can correct the image display error caused by the deformation of the head-mounted device and automatically realize the display calibration of the head-mounted device.

As one possible implementation, the present embodiment may determine the human eye gazing position by the following way: a plurality of infrared light emitting diodes (all called IR LED light) are provided on the border of the head-mounted device and are illuminated: determining a gazing direction according to a relative position of projection of the infrared light emitting diodes in a human eye in the first eye image with respect to a pupil; calculating the human eye gazing position according to the gazing direction and a human eye position.

As a possible implementation, the head-mounted device may specifically be an AR head-mounted device, and the process of the SOC adjusting the screen display position includes: generating a control command according to the positional deviation information and adjusting the screen display position of the head-mounted device by sending the control command to a stepper motor: wherein the control command is a command for adjusting relative positions of an AR optical machine and an AR lens (such as a waveguide sheet). The above control command can be generated in the following ways: determining a coordinate offset of a display screen according to the positional deviation information, and generating the control command according to the coordinate offset of the display screen. Specifically, in the above embodiment, the stepper motor adjusts the relative positions of the AR optical machine and the AR lens according to the received control command, so as to adjust the screen display position of the head-mounted device. Optionally, the above stepper motor may be connected with the AR optical machine or the AR lens.

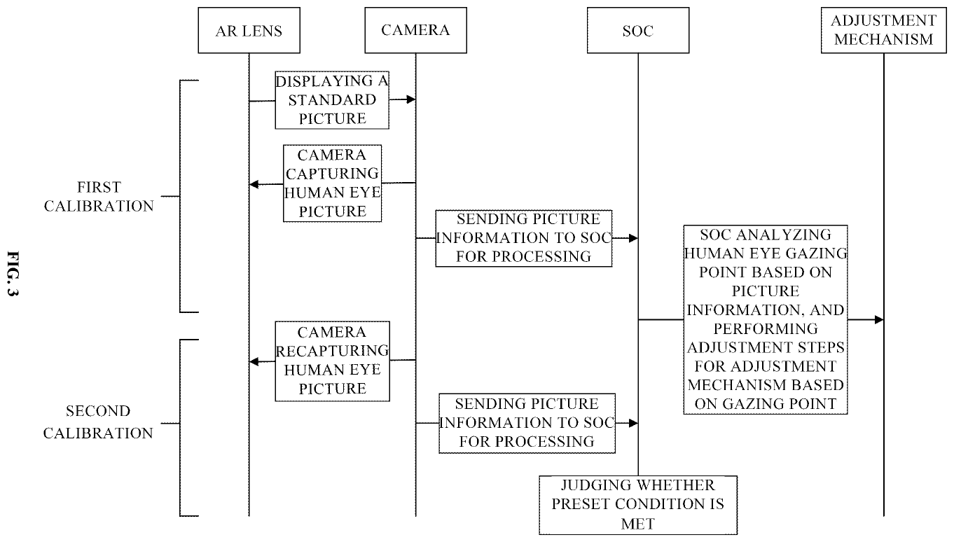

As a possible implementation, before taking a first eye image when a user wears the head-mounted device, further comprising: displaying a reference picture in a display area of the head-mounted device, so as to ensure that the human eye gazing point is relatively fixed, and to minimize the error caused by the beating of the human eye. Please refer to FIG. 2, FIG. 2 is a schematic diagram of a reference picture provided by an embodiment of the present disclosure. The reference picture shown in FIG. 2 comprises a plurality of feature points P that are all symmetrically distributed with respect to the preset gazing position.

As a possible implementation, after adjusting a screen display position of the head-mounted device according to the positional deviation information, further comprising an operation of a second judgment, the specific process of which is as follows: controlling the camera to take a second eye image, and judging whether positional deviation information of a human eye gazing position corresponding to the second eye image compared to the preset gazing position meets a preset condition: if yes, outputting a prompt message indicating that a calibration is completed: if not, adjusting the screen display position of the head-mounted device according to current positional deviation information, so as to recalibrate the display screen of the head-mounted device.

Due to the different eye habits of different users, different users can have different human eye gazing points when wearing the head-mounted device. The present embodiment can perform the operation of the embodiment corresponding to FIG. 1 after the wearer is replaced, and the specific process is as follows: when the head-mounted device is detected to be in a wearing state, judging whether a facial feature of a current user is the same as that of a previous user: if not, returning to the step of controlling a camera to take a first eye image.

The flow described in the above embodiment is described below through a control strategy for automatically realizing the binocular calibration of AR glasses in a practical application.

There are three major technical points in AR technology: three-dimensional registration, virtual reality fusion display, and human-computer interaction, wherein a goal of the virtual reality fusion display is to make relevant contents of the virtual world to be superimposed in the real world, which involves the display technology as well as analysis and research of biological characteristics of the human eye.

There are two challenges in the cooperation between the AR optical system and the human eye:
Challenge 1, convergence conflict: the mismatch between the distance between the eye and the object and the focus leads to visual fatigue such as blur and dizziness.
Challenge 2, abnormal overlap of binocular vision: the images seen by the left eye and the right eye are ultimately synthesized by the brain into a single picture, and if the deviation of the images displayed by the display system is too large, the pictures of the left eye and the right eye will be forcibly synthesized by the brain, resulting in fatigue such as dizziness.

In order to solve or reduce the occurrence of visual fatigue, calibration is usually added to the production line to ensure that the images of the left eye and the right eye can be overlapped into a single image at a distance of the virtual image distance. However, due to the process tolerance in the assembly process and the deformation of the frame in the actual use of the lens, the actual effect of the calibration process in the production line will be affected.

In view of the above problem, the present embodiment uses a camera to capture a human eye gazing point, analyzes and determines the position of the corresponding screen according to the gazing point, and then uses the electronic mechanism of the display system to automatically adjust the relative position of the AR lens or the optical machine, so that the final imaging matches the needs of the human eye, thereby realizing the overlap of binocular vision.

Please refer to FIG. 3, FIG. 3 is a schematic diagram of a binocular calibration process for an AR glass provided by an embodiment of the present disclosure. The operation process corresponding to FIG. 3 includes a first calibration and a second calibration, the second calibration is a review of a first calibration result, and the first calibration process is as follows: the AR lens displays a standard picture, the camera captures the human eye picture, the camera sends the picture information to the SOC for processing, and the SOC analyzes the human eye gazing point based on the picture information and performs adjustment steps of the adjustment mechanism (i.e., a stepping motor) based on the gazing point. In the second calibration, the human eye picture is recaptured, and the camera sends the picture information to the SOC for processing, and the SOC judges whether the preset condition is met: if so, the process is terminated, otherwise the adjustment step of the adjustment mechanism is executed.

In the calibration process, the AR lens of the AR glasses displays a standard picture, and the standard picture includes a plurality of key feature points: by displaying the key feature points, it is possible to ensure that the gazing point of the eye is relatively fixed, and to reduce the error caused by the beating of the human eye.

The purpose of taking a picture of the human eye using the camera of the AR glasses is to recognize the position of the pupil of the human eye, and thus infer the relative position of the currently displayed image with respect to the glasses. The process of taking a picture of the human eye using the camera is the same as that of eye tracking, that is, a plurality of infrared light-emitting diodes are arranged around the glasses frame to irradiate the human eye, and angle information of the pupil is determined by analyzing the relative position of the projection of the infrared light-emitting diodes in the human eye picture and the pupil. After obtaining a picture with gazing information of the pupil of the human eye, the picture can be passed to the SoC for image processing and, based on theoretical calculations, the final relative positional relationship between the human eye and the display device can be obtained so as to provide data support for the adjustment of the mechanism device in the following.

The present embodiment may add a stepper motor to the AR glasses, and control the relative positional relationship between the AR lens and the AR optical machine through the stepper motor, so as to realize the final adjustment of the display screen.

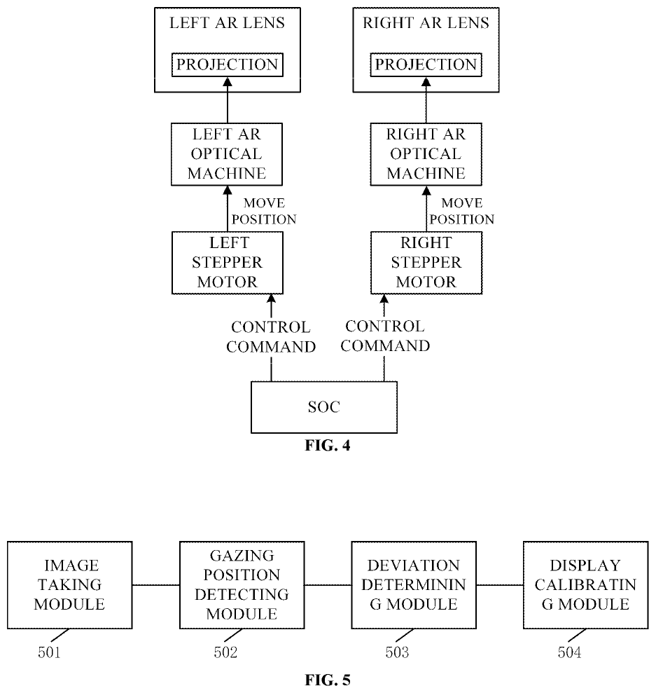

Please refer to FIG. 4, FIG. 4 is a control logic diagram of binocular calibration for an AR glass provided by an embodiment of the present disclosure. The SoC outputs control commands (e.g., move by 5 mm in X-axis, move by 1 mm in Y-axis) to the left stepper motor and the right stepper motor. The left stepper motor adjusts the position of the left AR optical machine according to the control command to adjust the displaying position of the display screen in the left AR lens, and the right stepper motor adjusts the position of the right AR optical machine according to the control command to adjust the displaying position of the display screen in the right AR lens.

The present embodiment utilizes a camera to capture and analyze the gazing point of the human eye, and analyzes the human eye state based on the gazing point to dynamically adjust the position of the AR lenses, thereby automatically aligning the binoculars and reducing the occurrence of convergence conflicts.

FIG. 5 is a schematic structural illustration of a display calibrating apparatus for a head-mounted device provided by an embodiment of the present disclosure. The apparatus may comprise:
an image taking module 501 configured for controlling a camera to take a first eye image when a user wears the head-mounted device;
a gazing position detecting module 502 configured for determining a human eye gazing position according to the first eye image; wherein the human eye gazing position is a position of a human eye gazing point on the head-mounted device;
a deviation determining module 503 configured for retrieving a preset gazing position of the head-mounted device and calculating positional deviation information of the preset gazing position compared to the human eye gazing position; and
a display calibrating module 504 configured for adjusting a screen display position of the head-mounted device according to the positional deviation information.

The present embodiment determines the human gazing position by taking a first eye image when a user wears the head-mounted device, and may determine the position of the human eye gazing point on the head-mounted device according to the human eye gazing position. The head-mounted device is provided with a preset gazing position so as to avoid the occurrence of convergence conflict and binocular vision overlap, such that there is no convergence conflict and no binocular visual overlap when the human eye gazing position is the preset gazing position. The present embodiment compares the preset gazing position with the human eye gazing position, and adjusts the screen display position according to the positional deviation information, thereby realizing the adjustment of the display screen of the head-mounted device. By adjusting the screen display position based on the actual human eye gazing position and the preset gazing position, the above solution can correct the image display error caused by the deformation of the head-mounted device and automatically realize the display calibration of the head-mounted device.

Further, the head-mounted device is provided with a plurality of infrared light emitting diodes on its border.

Correspondingly, the gazing position detecting module 502 is configured for determining a gazing direction according to a relative position of projection of the infrared light emitting diodes in a human eye in the first eye image with respect to a pupil; calculating the human eye gazing position according to the gazing direction and a human eye position.

Further, the head-mounted device is an AR head-mounted device, and the display calibrating module 504 is configured for generating a control command according to the positional deviation information and adjusting the screen display position of the head-mounted device by sending the control command to a stepper motor: wherein the control command is a command for adjusting relative positions of an AR optical unit and an AR lens.

Further, the display calibrating module 504 is configured for determining a coordinate offset of a display screen according to the positional deviation information, and generating the control command according to the coordinate offset of the display screen.

Further comprising:
a reference picture displaying module configuring for before taking a first eye image when a user wears the head-mounted device, displaying a reference picture in a display area of the head-mounted device, wherein the reference picture comprises a plurality of feature points that are all symmetrically distributed with respect to the preset gazing position.

Further comprising:
a second adjusting module configured for after adjusting a screen display position of the head-mounted device according to the positional deviation information, controlling the camera to take a second eye image, and judging whether positional deviation information of a human eye gazing position corresponding to the second eye image compared to the preset gazing position meets a preset condition: if yes, outputting a prompt message indicating that a calibration is completed: if not, adjusting the screen display position of the head-mounted device according to current positional deviation information.

Further comprising:
a user switching detection module configured for when the head-mounted device is detected to be in a wearing state, judging whether a facial feature of a current user is the same as that of a previous user: if yes, then starting the operation process of the image taking module 501.

Since the embodiment of the apparatus corresponds to the embodiment of the method, please refer to the description of the embodiment of the method for the embodiment of the apparatus, which will not be repeated herein.

The present disclosure also proposes a storage medium where a computer program is stored, and the computer program when executed may implement the steps provided by the above embodiments. The storage medium may include: U disk, mobile hard disk, Read-Only Memory (ROM), Random Access Memory (RAM), diskette or CD and other media that can store program code.

The present disclosure also proposes an electronic equipment comprising a memory and a processor, the memory stores a computer program therein, and the processor may implement the steps provided by the above embodiments when calling the computer program in the memory. Of course, the electronic equipment may also include various network interfaces, power supplies and other components.

Each embodiment in this specification is described in a progressive manner, and each embodiment focuses on its differences from other embodiments, and the same or similar parts between each embodiment can refer to each other. For the apparatus disclosed in the embodiments, the description is relatively simple because the apparatus corresponds to the method disclosed in the embodiments, and the relevant points can be found in the description of the method. It should be noted that for a person of ordinary skill in the art, several improvements and modifications can be made to the present disclosure without departing from the principles of the present disclosure, and these improvements and modifications also fall within the protection scope of the claims of the present disclosure.

It should also be noted that in this article, relational terms such as first and second, etc., are used solely to distinguish one entity or operation from another, and do not necessarily require or imply any such actual relationship or sequence between those entities or operations. Further, the term “comprise”, “include” or any other variation thereof is intended to cover non-exclusive comprising so that a process, method, article or apparatus that comprises a series of elements includes not only those elements, but also other elements that are not expressly listed, or also comprises elements inherent in such process, method, article or apparatus. Without further limitation, the elements defined by the phrase “comprising a . . . ” do not preclude the existence of other identical elements in the process, method, article or apparatus that includes the elements.

1. A display calibration method for a head-mounted device, comprising:
controlling a camera to capture a first eye image of a human eye of a user wearing the head-mounted device;
determining a human eye gazing position according to the first eye image, wherein the human eye gazing position comprises a position of a human eye gazing point on the head-mounted device;
retrieving a preset gazing position of the head-mounted device and calculating positional deviation information by comparing the preset gazing position to the human eye gazing position; and
adjusting a screen display position of the head-mounted device according to the positional deviation information.

2. The display calibration method for a head-mounted device according to claim 1, wherein the head-mounted device comprises a plurality of infrared light emitting diodes on a border thereof:
wherein the determining a human eye gazing position according to the first eye image comprises;
determining a gazing direction according to a relative position of a projection of the infrared light emitting diodes in the human eye according to the first eye image with respect to a pupil of the human eye; and
calculating the human eye gazing position according to the gazing direction and the human eye position.

3. The display calibration method for a head-mounted device according to claim 1, wherein the head-mounted device is an AR head-mounted device, and the adjusting a screen display position of the head-mounted device according to the positional deviation information, comprises:
generating a control command according to the positional deviation information, and adjusting the screen display position of the head-mounted device by sending the control command to a stepper motor to adjust relative positions of an AR optical machine and an AR lens.

4. The display calibration method for a head-mounted device according to claim 3, wherein the generating a control command according to the positional deviation information, comprises:
determining a coordinate offset of the screen display according to the positional deviation information, and generating the control command according to the coordinate offset of the screen display.

5. The display calibration method for a head-mounted device according to claim 1, wherein before the capturing the first eye image the method further comprises:
displaying a reference picture in a display area of the head-mounted device, wherein the reference picture comprises a plurality of feature points symmetrically distributed with respect to the preset gazing position.

6. The display calibration method for a head-mounted device according to claim 1, wherein after the adjusting the screen display position of the head-mounted device according to the positional deviation information, the method further comprises:
controlling the camera to capture a second eye image, and judging whether the positional deviation information of the human eye gazing position corresponding to the second eye image compared to the preset gazing position meets a preset condition;
if the preset condition is met, outputting a prompt message indicating that a calibration is completed;
if the preset condition is not met, adjusting the screen display position of the head-mounted device according to the positional deviation information.

7. The display calibration method for a head-mounted device according to claim 1, further comprising:
when the head-mounted device is detected to be in a wearing state, judging whether a facial feature of the user is the same as that of a previous user;
if not, repeating the controlling a camera to capture a first eye image.

8. A display calibrating apparatus for a head-mounted device, comprising:
an image capture module configured for controlling a camera to capture a first eye image of a human eye of a user upon wearing the head-mounted device;
a gazing position detecting module configured for determining a human eye gazing position according to the first eye image, wherein the human eye gazing position comprises a position of a human eye gazing point on the head-mounted device;
a deviation determining module configured for retrieving a preset gazing position of the head-mounted device and calculating positional deviation information by comparing the preset gazing position to the human eye gazing position; and
a display calibrating module configured for adjusting a screen display position of the head-mounted device according to the positional deviation information.

9. A head-mounted device comprising a memory and a processor, wherein the memory stores a computer program therein, and the processor is configured for implementing the display calibration method for a head-mounted device according to claim 1 when the computer program in the memory is called.

10. A storage medium, for storing a computer executable instruction therein, wherein the computer executable instruction is configured to be loaded and executed by a processor to implement the display calibration method for a head-mounted device according to claim 1.
